(19) United States
(12) Patent Application Publication
(10) Pub. No.: US 2024/0099318 A1
(43) Pub. Date: Mar. 28, 2024

(54) APPARATUS AND METHOD FOR LOW-TEMPERATURE AGING USING SLURRY ICE

(71) Applicant: Jong-Su BYEON, Seoul (KR)

(72) Inventor: Jong-Su BYEON, Seoul (KR)

(21) Appl. No.: 18/267,749

(22) PCT Filed: Dec. 16, 2021
(86) PCT No.: PCT/KR2021/019132

§ 371 Date: Jun. 15, 2023

(30) Foreign Application Priority Data
Dec. 24, 2020 (KR) 10-2020-0182897

(51) Int. Cl. A23B 4/08; A23B 4/26; A23L 3/00

(52) U.S. Cl. CPC A23B 4/08; A23B 4/26; A23L 3/003

(57) ABSTRACT

Provided is an apparatus or low-temperature aging using slurry ice including: a slurry ice producing part that adjusts the salinity of a brine so as to produce slurry ice at a target temperature; and an aging tank in which food to be aged is stored at the target temperature, for low-temperature aging, in the slurry ice produced by the slurry ice producing part, wherein by aging the food to be aged, especially meat such as pork, beef, and the like at a low temperature so that the food to be aged does not freeze at sub-zero temperatures, using the slurry ice, the freshness of the meat can be maintained and the texture thereof can be improved.

### TECHNICAL FIELD

The present invention relates to a low-temperature aging apparatus using ice slurry, and more particularly, to a low-temperature aging device and method using ice slurry in which food desired to be matured, especially meat such as pork or beef is subjected to low-temperature aging using ice slurry to prevent the meat from freezing at sub-zero temperatures, thereby preserving the freshness of the food and enhancing its texture.

### BACKGROUND ART

In general, meat aging is broadly divided into dry aging and wet aging. Dry aging refers to a process in which a cut of meat is naturally aged by exposing it to the air for approximately two to four weeks in a controlled environment, as in a low-temperature refrigerator, where specific temperatures, humidity, and ventilation are maintained. The dry aging process allows moisture to evaporate from the meat muscles to add the rich flavor of the meat, and allows natural enzymes to break down the connective tissue in the muscles to tenderize the meat. However, the dry aging method has drawbacks in that it causes a reduction in meat weight, ranging from 5% to 20%, as moisture evaporates, and in that the exposure of the meat to air leads to the excessive drying of the meat or the growth of molds and spoilage on the meat surface, which necessitates the elimination (i.e., trimming) of the affected outer surface portions of the meat, resulting in a decrease of over 50% in the meat weight compared to regular meat, and thus an increase in the meat cost. On the other hand, wet aging refers to a process in which meat is vacuum-packaged and then is artificially aged in a refrigerated warehouse. The wet aging method is a common process which has become widely employed since it prevents the reduction in meat weight, caused by being dried or mold growth, resulting in no loss of yield and low maintenance costs.

However, when aging the meat in the refrigerated warehouse with a temperature ranging from 0° C. to 10° C., a significant temperature deviation (approximately ±5° C.) occurs, leading to a deterioration of the meat if aged for a long period of time. For example, a refrigerated warehouse set at 0° C. has a temperature range between 5° C. above freezing and 5° C. below freezing. In this case, for beef frozen at −1.7° C., freezing and thawing cycles are repeated, making it unable to endure the optimal aging period and resulting in the deterioration of the beef. For this reason, it is necessary to shorten the aging period, making it impossible to achieve the same quality as that of dry-aged beef. Furthermore, the frequent entry and exit into and from the refrigerated warehouse makes it difficult to maintain a consistent internal temperature. As a result, the texture and flavor of meat aged in the wet aging manner significantly deteriorates compared to the dry-aged meat. As an attempt to address and solve these problems, a refrigerated warehouse with a precise temperature deviation and other devices have been developed. However, the costs required for such facility and devices are considerably high, and achieving the desired level of precise temperature control remains a challenge. In order to enhance the texture and flavor of wet-aged meat to the level achieved by dry aging, it is required the meat be preserved within a specific temperature range for a predetermined period of time.

Korean Patent No. 10-1950406 entitled “Method for Aging Meat at An Ice-Cold Temperature” (issued on May 21, 2019) discloses a method for ice-cold aging fresh meat such as pork or beef, which is consumed as raw meat. In the method, the meat is aged at an ice-cold temperature, i.e., a temperature at or near the temperature of ice for a specific period of time using gel ice in an environment maintained at −1° C. in such a manner that the meat is aged under conditions where it does not freeze, based on the freezing point of each type of meat, thereby preserving the freshness of the meat and improving its texture. Water and gel ice are circulated by an aeration device disposed inside an aging tank by use of a protrusion bent downwardly from a lid of the aging tank.

Korean Patent No. 10-2072626 entitled “Brine Chiller System with Automatic Salinity Control Enabled” (issued on Mar. 2, 2020) discloses a brine chiller system with automatic salinity control enabled, which can automatically adjust the salinity and temperature of a brine within a brine tank based on preset values as well as rotate a rotating unit using the jet force of the brine without requiring a separate power source, thereby uniformly maintaining the salinity and temperature of the brine within the brine tank.

### DISCLOSURE OF INVENTION

### Technical Problem

Accordingly, the present invention has been made to solve the aforementioned problems occurring in the prior art, and it is an object of the present invention to provide a low-temperature aging device and method using ice slurry in which food desired to be matured, especially meat such as pork or beef is subjected to low-temperature aging to prevent the meat from freezing at sub-zero temperatures, thereby preserving the freshness of the meat and enhancing its texture.

Another object of the present invention is to provide a low-temperature aging apparatus and method which exhibits a small change in temperature during low-temperature aging and allows for easy adjustment of the low-temperature aging temperatures for various types of food.

Still another object of the present invention is to provide a low-temperature aging apparatus and method which rapidly kills spoilage-causing bacteria such as E. coli, Staphylococcus aureus, and Vibrio harveyi on the surface of food, significantly contributing to the improvement of freshness preservation.

The objects of the present invention are not limited to the objects mentioned above, and other objects not mentioned will be clearly understood by those skilled in the art from the following description.

### Technical Solution

To achieve the above objects, in one aspect, the present invention provides a low-temperature aging apparatus that ages food at a low temperature below freezing using ice slurry containing salt, the apparatus, including: an ice slurry generation unit configured to produce and supply an ice slurry with a uniform salinity; an aging tank comprising a storage container configured to store food that is desired to be aged at a low temperature, an ice slurry inlet formed on an upper portion of the storage container and connected to the ice slurry generation unit, an inlet valve configured to control the opening and closing of the ice slurry inlet, a brine outlet disposed on a lower portion of the storage container and configured to discharge a brine, an outlet valve configured to control the opening and closing of the brine outlet, a quantity meter configured to measures the quantity of the ice slurry contained in the aging tank, and a thermometer configured to measure the temperature of an ice slurry contained in the aging tank; and a control unit configured to receive measurement signals from the thermometer and the quantity meter to control the operations of the inlet valve and the outlet valve, wherein the control unit controls the brine to be discharged through the brine outlet and controls ice slurry to be supplied to the aging tank through the ice slurry inlet if the temperature of the ice slurry contained in the aging tank goes beyond a predetermined temperature range.

The ice slurry generation unit may include: a brine tank configured to store the brine therein; an ice slurry transfer unit configured to cool the brine supplied from the brine tank while transferring the brine and convert the cooled brine into the ice slurry; and a cooling unit configured to cool the internal temperature of the ice slurry transfer unit to a temperature below the freezing point of the brine.

The low-temperature aging apparatus may further include a recovery tank connected to the brine outlet of the aging tank and configured to store the brine transferred (discharged) from the aging tank and to supply the stored brine to the ice slurry generation unit.

The low-temperature aging apparatus may further include a sterilized water generation unit disposed between the recovery tank and the ice slurry generation unit and configured to supply sterilized water to the ice slurry generation unit.

The sterilized water generation unit may include: a neutralization reaction unit configured to neutralize sodium hypochlorite (NaOCl) with dilute hydrochloric acid (HCl); and a mixing unit configured to mix hypochlorous acid produced by the neutralization reaction unit with water.

To achieve the above objects, in another aspect, the present invention provides a low-temperature aging method that ages food at a low temperature below freezing using ice slurry containing salt, the method including the steps of: allowing an ice slurry generation unit to produce an ice slurry with a uniform salinity; allowing a control unit to receive the temperature of an ice slurry of an aging tank, which is measured by a thermometer of the aging tank, from the thermometer; allowing the control unit to check whether or not the temperature of the ice slurry goes beyond a predetermined temperature range; allowing the control unit to control an outlet valve to be opened to discharge a brine through a brine outlet if the temperature of the ice slurry goes beyond the predetermined temperature range; and allowing the control unit to check a signal outputted from a quantity meter and control an inlet valve to be opened to supply the ice slurry to the aging tank through an ice slurry inlet until the level of the ice slurry reaches a predetermined height.

The ice slurry producing step may include the steps of: being supplied with a brine from a brine tank and transferring the brine to the interior of an ice slurry transfer unit; cooling the ice slurry transfer unit to a temperature below the freezing point of the brine and converting the brine passing through the interior of the ice slurry transfer unit into the ice slurry; and storing the converted ice slurry in the brine tank.

The low-temperature aging method may further include the steps of: transferring the brine contained in the aging tank to a recovery tank; and transferring the brine of the recovery tank to the ice slurry generation unit.

The low-temperature aging method may further include supplying sterilized water to the ice slurry generation unit.

### Advantageous Effects

As described above, the present invention has an advantageous effect in that food desired to be matured, especially meat such as pork or beef is subjected to low-temperature aging using ice slurry to prevent the meat from freezing at sub-zero temperatures, thereby preserving the freshness of the meat and enhancing its texture.

In addition, the present invention has an advantage in that ice slurry with optimum temperatures for various types of food can be produced through the adjustment of the salinity of the brine so that the low-temperature aging temperature can be adjusted stably and easily.

Further, the present invention has an advantageous effect in that the ice slurry produced by adding hypochlorous acid water to brine is used to age food or meat, so that spoilage-causing bacteria such as E. coli, Staphylococcus aureus, and Vibrio harveyi on the surface of food can be rapidly killed due to high bactericidal activity of hypochlorous acid, significantly contributing to the improvement of freshness preservation.

### BRIEF DESCRIPTION OF THE DRAWINGS

FIG. 1 is a block diagram illustrating a schematic configuration of a low-temperature aging apparatus using ice slurry according to an embodiment of the present invention.

FIG. 2 is a diagrammatic view illustrating a configuration of an ice slurry generation unit 100 according to an embodiment of the present invention.

FIG. 3 is a diagrammatic view illustrating a configuration of an aging tank 200 according to an embodiment of the present invention.

FIG. 4 is a block diagram illustrating a configuration of a sterilized water generation unit 300 according to an embodiment of the present invention.

FIG. 5 is a graph depicting the concentrations of hypochlorous acid (HOCl) and hypochlorite ion (OCl—) along with the time required to kill E. coli.

FIG. 6 is a diagrammatic view illustrating the entire configuration of a low-temperature aging apparatus using ice slurry according to an embodiment of the present invention.

FIG. 7 is a control flowchart illustrating a low-temperature aging method using ice slurry according to an embodiment of the present invention.

FIG. 8 is a flowchart illustrating a low-temperature aging method using ice slurry by constituent element according to an embodiment of the present invention.

### BEST MODE FOR CARRYING OUT THE INVENTION

Hereinafter, the preferred embodiments of the present invention will be described in further detail with reference to the accompanying drawings so that the present invention may be easily carried out by those skilled in the art to which the present invention pertains. However, the embodiments are intended to more specifically describe the present invention, and it will be obvious to those skilled in the art that the scope of the present invention is not limited thereto.

The configuration of the present invention for clarifying a solution to the problem to be solved by the present invention will be described in detail below with reference to the accompanying drawings based on the preferred embodiments of the present invention. In the meantime, it should be noted in advance that in assigning reference numerals to the elements of the drawings, the same reference numerals are assigned to the same elements even though the same elements are on different drawings and elements of other drawings may be cited if necessary in describing the corresponding drawings. In addition, when it is determined that detailed descriptions of known functions or configurations related to the present invention and other matters may unnecessarily obscure the subject matter of the present invention in describing the operating principle of the preferred embodiment of the present invention in detail, the detailed descriptions thereof will be omitted.

Further, throughout the specification, when it is mentioned that one part is “connected” to another part, it includes not only the case of “direct connection” but also the case of “indirect connection” via other elements therebetween. As used herein, the singular forms “a,” “an” and “the” are intended to include the plural forms as well as the singular forms, unless the context clearly indicates otherwise. Additionally, the terms, “comprises” and “comprising,” when used in this specification, specify the presence of the stated features, steps, operations, elements, and/or components, but do not preclude the presence or addition of one or more other features, steps, operations, elements, and/or components.

In the present invention, there is provided a low-temperature aging apparatus which produces ice slurry by adjusting the salinity of a brine so that other aging temperatures can be effectively maintained depending on food that is desired to be aged.

Ice slurry, which is neither fully liquid nor solid, provides much easier temperature control when vacuum-packed meat is submerged in the ice slurry compared to a conventional refrigerated warehouse that controls the ambient air temperature.

In addition, each type of meat has a different freezing point, and the present invention adjusts the salinity of the brine to stably produce ice slurry of a desired temperature so that the meat can be stably stored within a precise temperature range during meat maturation.

Further, in the process of dressing out and vacuum-packaging meat after slaughtering it using sterilized water containing hypochlorous acid, when sterilization is performed, more stable aging can be progressed for an extended period of time. Furthermore, when ice slurry is produced using sterilized water, a bactericidal effect can be expected even during the aging process.

The temperature during aging is very crucial for food desired to be aged, especially meat, which is required to be subjected to low-temperature aging. The freezing point of meat is in the range of approximately −1.6° C. to −1.7° C. If the freezing temperature is less than the lower limit of the above range, the meat will start to freeze from its surface. On the contrary, if the freezing temperature exceeds 0° C., the maintenance of the freshness of the meat will be challenging during long-term aging.

The temperature range of 0° C. to 10° C. is commonly referred to as “refrigerating”, and the temperature range below the freezing point (e.g., below −1.6° C. for pork, and below −1.7° C. for beef) is considered “freezing”. However, the temperature range from the freezing point to 0° C. for each type of meat (e.g., −1.6° C. to 0° C. for pork, −1.7° C. to 0° C. for beef) is known as the third temperature zone. The storage of a relevant product within the above temperature range may result in the following beneficial effects.

i) It is possible to maintain an optimal hygienic environment through the reduction of harmful microorganisms. In the conventional aging methods, as bacteria proliferate and the aging period extends, hygiene is compromised. On the other hand, in a low-temperature environment below 0° C., harmful microorganisms that cause food poisoning decrease in a deactivated state.

ii) It is possible to maintain a high level of freshness. Through aging and storage at a much lower temperature than that of the conventional dry aging, the food itself does not deteriorate, allowing for the maintenance of high quality and freshness.

iii) Flavor components increase. Living organisms such as animals and plants trigger their self-defense instincts to protect themselves from freezing in a low temperature environment below 0° C., leading to an increase in body fluids present within their bodies. The body fluids contain flavor components such as sugars and amino acids, resulting in an increase in the total quantity of flavor components in the food itself, and thus making the food taste more delicious.

The freezing points by food item are listed in Table 1 below.

TABLE 1

| | Food Type | | | | | | | | | | | |
|---|---|---|---|---|---|---|---|---|---|---|---|---|
| | | | | | | | | | | | Blue | |
| | Beef | Pork | Sardine | Tomato | Lettuce | Potato | Apple | Grape | Cherry | Flounder | crab | Mackerel |
| Freezing | −1.7 | −1.6 | −1.4 | −0.5 | −1.2 | −2.0 | −2.2 | −2.5 | −3.7 | −2.0 | −2.2 | −1.8 |
| point (° C.) | | | | | | | | | | | | |

As shown in Table 1 above, each type of meats, vegetables, and fruits has its own specific freezing point. By adjusting the salinity of the brine, the freezing point may vary depending on the salinity. Therefore, it is possible to control the temperature of ice slurry. The most important aspect in aging meat is precise temperature control. However, a current refrigerated warehouse-type aging facility and a water circulation-type aging facility have a temperature deviation of ±5° C., making precise control impossible. In contrast, the present invention, which will be described below, enables precise temperature control.

The freezing point of the brine is depressed depending on the molar concentration, i.e., the molarity of a solute. In other words, if the molarity of the solute is denoted by “m” and the molar freezing point depression (or cryoscopic) constant of the solvent is denoted by “K_{f}”, the freezing point depression ΔT_{f} (of the solvent) can be calculated by the following Equation 1:

ΔT_{f}=K_{f}·m [Equation 1]

In the case of brine, since the molar freezing point depression constant (K_{f}) of water which is a solvent is 1.86° C./m, the freezing point depression is 1.86 m.

For instance, since 100 g of a 20% brine means that 20 g of a solute (salt) is dissolved in 80 g of a solvent (water), the molarity (m) of the solute is 4.2775 m (i.e., 0.3422 mol/0.080 kg=4.2775 m). Therefore, the freezing point depression of the solvent is 7.96 (i.e., 1.86*4.2775=7.96). In other words, 100 g of a 20% brine will generate ice at −7.96° C. Table 2 illustrates the freezing point calculated based on the brine concentration (salinity, wt %).

TABLE 2

| | Brine concentration (wt %) | | | | | | | | | |
|---|---|---|---|---|---|---|---|---|---|---|
| | 20 | 10 | 7 | 5 | 4.5 | 4 | 3 | 2 | 1.5 | 1 |
| Freezing | −8.0 | −3.6 | −2.4 | −1.7 | −1.5 | −1.3 | −1.0 | −0.7 | −0.5 | −0.3 |
| point (° C.) | | | | | | | | | | |

The target temperature may be set differently depending on the type of food which is desired to be aged at lower temperature. The adjustment of the salinity to fit the target temperature may produce an ice slurry corresponding to the target temperature.

For instance, since the freezing points for beef and pork are −1.7° C. and −1.6° C., respectively, the target temperatures of an ice slurry for beef and pork may be set −1.5° C. to −0.5° C., respectively. In this case, the ice slurry having a uniform temperature with a freezing point ranging from −1.5° C. to −0.5° C. may be obtained using a brine with a salinity of 1.5% to 4.5%. When food is aged at a low temperature using such ice slurry, livestock products such as beef and pork, which have a freezing point lower than −1.5° C., seafoods such as flounder, blue crab, and mackerel, and agricultural products potatoes, apples, grapes, and cherries may be stably subjected to low-temperature aging without freezing these products.

Preferably, the ice slurry has an average particle diameter of 1.0 mm or less to achieve uniform dispersion of the particles, and more preferably, the ice slurry may have a particle diameter in the range of 0.1 mm to 0.5 mm.

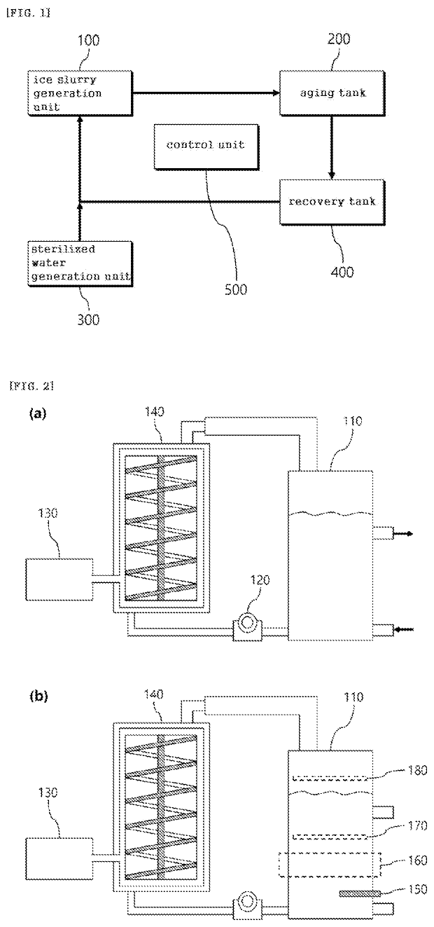

FIG. 1 is a block diagram illustrating a schematic configuration of a low-temperature aging apparatus using ice slurry according to an embodiment of the present invention.

The low-temperature aging apparatus using ice slurry according to an embodiment of the present invention may age food at a low temperature below freezing using ice slurry containing salt. Referring to FIG. 1, the low-temperature aging apparatus using ice slurry according to an embodiment of the present invention includes an ice slurry generation unit 100, an aging tank 200, a recovery tank 400, a sterilized water generation unit 300, and a control unit 500.

The ice slurry generation unit 100 is a device that produces and supplies an ice slurry of a desired temperature through the adjustment of the salinity of a brine. The ice slurry generation unit 100 converts a brine having a uniform salinity of 1.5% to 4.5% into an ice slurry. The produced ice slurry has a uniform temperature with a freezing point ranging from −1.5° C. to −0.5° C. The ice slurry has an average particle diameter of 1.0 mm or less to achieve uniform dispersion of the particles, and preferably, the ice slurry may have a particle diameter in the range of 0.1 mm to 0.5 mm.

The aging tank 200 is supplied with ice slurry from the ice slurry generation unit 100 to age food stored therein at a low temperature. Since the ice slurry has a uniform temperature ranging from −1.5° C. to −0.5° C., livestock products such as beef and pork, which have a freezing point lower than −1.5° C., seafoods such as flounder, blue crab, and mackerel, and agricultural products potatoes, apples, grapes, and cherries may be stably subjected to low-temperature aging without freezing these products.

The recovery tank 400 stores the ice slurry and the brine discharged from the aging tank and supplies the stored brine to the ice slurry generation unit to circulate the brine within the low-temperature aging apparatus. Sterilized water generated from the sterilized water generation unit 300 may be added to the brine supplied from the aging tank to the ice slurry generation unit. The sterilized water may inhibit bacterial growth in the ice slurry and control the salinity.

The control unit 500 checks whether or not the internal temperature of the aging tank is constant, and controls the aging tank to discharge the brine in order to maintain a constant internal temperature of the aging tank. It also controls the ice slurry produced from the ice slurry generation unit to be additionally supplied to the aging tank. The control unit 500 controls the brine discharged from the aging tank to be transferred to and stored in the recovery tank, and the sterilized water generated from the sterilized water generation unit to be added to the brine stored in the recovery tank for application to the ice slurry generation unit. An ice slurry with an adequate salinity may be produced by measuring the salinity of the recovery tank and the ice slurry generation unit and adjusting the salinity and the quantity of the sterilized water added.

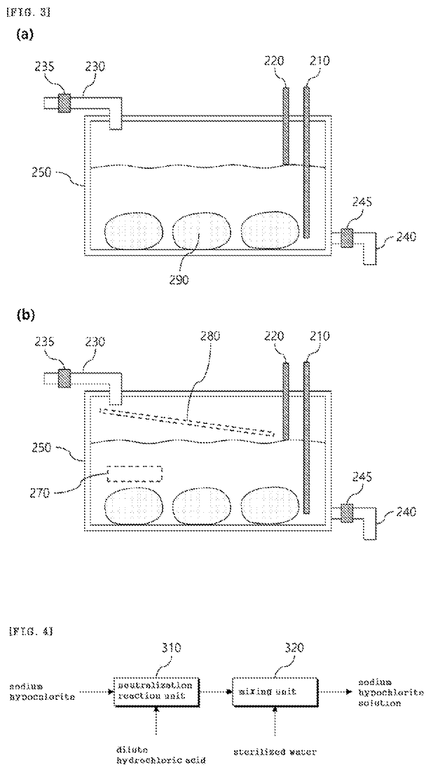

FIG. 2 is a diagrammatic view illustrating a configuration of an ice slurry generation unit 100 according to an embodiment of the present invention.

Referring to FIG. 2(a), the ice slurry generation unit 100 according to an embodiment of the present invention includes a brine tank 110, a pump 120, a cooling unit 130, and an ice slurry transfer unit 140.

The ice slurry generation unit 100 is a device that produces an ice slurry of a desired temperature by adjusting the salinity of the brine.

The brine tank 110 stores the brine therein. The brine is pumped to the ice slurry transfer unit 140 by a pump 120. The brine supplied into the brine tank 110 may be the brine stored in and discharged from the recovery tank 400, and may be a mixture of the brine and the sterilized water generated from the sterilized water generation unit 300.

The pump 120 pumps the brine stored in the brine tank 110 to the ice slurry transfer unit 140.

The cooling unit 130 circulates a refrigerant through the ice slurry transfer unit 140 to lower the internal temperature of the ice slurry transfer unit 140 to a desired temperature. The cooling unit 130 may cool the internal temperature of the ice slurry transfer unit 140 to a temperature below the freezing point of the brine.

The ice slurry transfer unit 140 cools the brine supplied from the brine tank while transferring the brine and converts the cooled brine into the ice slurry. The ice slurry transfer unit 140 is supplied with either the brine or a brine containing the sterilized water from the brine tank 110 with the aid of pumping action of the pump in a state where its interior has been cooled by the cooling unit 130. A screw conveyor or a screw feeder is preferably mounted in the internal space of the ice slurry transfer unit 140 to transfer the ice slurry.

The brine cooled while being transferred by the screw conveyor of the ice slurry transfer unit 140 is re-supplied to the brine tank 110.

In the process in which the brine is transferred between the brine tank 110 and the ice slurry transfer unit 140, the brine initially stored in the brine tank 110 is converted into an ice slurry of a desired temperature and the converted ice slurry is cumulatively stored in the brine tank 110.

In other words, initially, the brine tank 110 is filled only with brine. As the brine is transferred to the ice slurry transfer unit 140, which has been cooled by the cooling unit 130, the brine stored in the brine tank 110 is gradually converted into ice slurry over time.

The ice slurry transfer unit 140 according to an embodiment of the present invention is preferably a triple-layered cylindrical structure made of a stainless steel material that is resistant to oxidation or damage by the brine. This triple-layered cylindrical structure may effectively block heat to prevent the ice slurry flowing inside the ice slurry transfer unit 140 from being influenced by the external temperature.

The cooling unit 130 may overcool the brine flowing inside the ice slurry transfer unit 140. To this end, a helical ice slurry feeding device may be installed at the inner center of the ice slurry transfer unit 140 to allow for excessive cooling of the brine supplied to a lower portion of the ice slurry transfer unit 140.

Preferably, the brine overcooled by the ice slurry transfer unit 140 is converted into the ice slurry, which is then discharged through an outlet line installed at the upper end of the ice slurry transfer unit 140 so as to be transferred to the brine tank 110.

In the meantime, when the ice slurry and the brine are mixed together in the brine tank 110, the brine is transferred to the ice slurry transfer unit 140 and converted into an ice slurry of fine particles in the ice slurry transfer unit 140. Subsequently, the ice slurry is returned to the brine tank 110, resulting in a gradual accumulation of the ice slurry in the brine tank 110.

In this case, a brine with a salinity required to store an ice slurry of a desired temperature in the brine tank 110 is prepared and supplied to the lower end portion of the ice slurry transfer unit 140 using the pump 120. The converted ice slurry is then discharged through the upper outlet line of the ice slurry transfer unit 140 and recovered to the brine tank 110. This process is performed repeatedly until the brine is fully converted into the ice slurry as the temperature of the brine drops.

When a brine with a uniform salinity of 1.5% to 4.5% is supplied to the brine tank 110, the ice slurry produced from the brine tank 110 has a uniform temperature with a freezing point ranging from −1.5° C. to −0.5° C. This the ice slurry enables the stable low-temperature aging of livestock products such as beef and pork, which have a freezing point lower than −1.5° C., seefoods, and agricultural products to be stably subjected to low-temperature aging without freezing them.

Preferably, the ice slurry has an average particle diameter of 1.0 mm or less to achieve uniform dispersion of the particles, and more preferably, the ice slurry may have a particle diameter in the range of 0.1 mm to 0.5 mm.

FIG. 2(b) is a diagrammatic view illustrating a configuration of an ice slurry generation unit 100 according to another embodiment of the present invention. Referring to FIG. 2(b), the ice slurry generation unit 100 according to another embodiment of the present invention may further include salinity meter 150, a thermostat 160, a first mesh 170, and a second mesh 180.

The salinity meter 150 measures the salinity of the brine at the lower portion of the brine tank. The thermostat 160 may maintain the lower portion of the brine tank at a temperature where the brine does not freeze, ensuring accurate salinity measurement.

The first mesh 170 and the second mesh 180 may be installed to limit the particle size of the ice slurry. The second mesh filters an ice slurry with an unsuitable article diameter that is too large to be supplied into the aging tank. The brine tank may be divided into a lower brine part and an upper ice slurry part. The first mesh preferably has a mesh spacing narrower than that of the second mesh. For instance, the first mesh may use a 35 mesh screen, and the second mesh may use an 18 mesh screen.

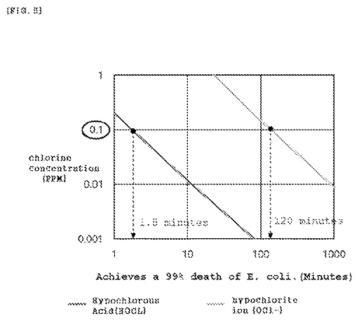

FIG. 3 is a diagrammatic view illustrating a configuration of an aging tank 200 according to an embodiment of the present invention.

Referring to FIG. 3(a), the aging tank 200 according to an embodiment of the present invention includes a storage container 250, a thermometer 210, a quantity meter 220, an ice slurry inlet 230, an inlet valve 235, a brine outlet 240, and an outlet valve 245.

The aging tank 200 is a device that stores meats, vegetables, and fruits at a constant temperature for a desired period of time for the purpose of low-temperature aging.

The storage container 250 stores food 290 that is desired to be aged at a low temperature.

The thermometer 210 measures the temperature of the ice slurry inside the aging tank 200. The thermometer is preferably installed within the aging tank in such a manner that a measuring part of the thermometer is located at the lower portion of the aging tank, where the food is placed.

The quantity meter 220 measures the quantity of the ice slurry contained in the aging tank 200. The quantity of the ice slurry contained in the aging tank 200 may be measured from the bottom of the aging tank 200 to the height of the tank where the ice slurry is contained.

If the internal temperature of the aging tank (200) goes beyond, i.e., exceeds or is less than a predetermined temperature range, a separate wireless communication or alarm device may be used to notify the control unit or a user of the temperature measured by the thermometer 210. Preferably, the separate wireless communication or alarm device may also be used to notify the control unit or the user of the quantity measured by the quantity meter 220. Examples of the wireless communication may include LTE, WiFi, Bluetooth, Zigbee and the like.

The ice slurry inlet 230 is an inlet through which the ice slurry discharged from the brine tank 110 is introduced into the aging tank 200 shown in FIG. 2. The ice slurry inlet 230 is formed on an upper portion of the storage container 250 and is connected to the ice slurry generation unit.

The inlet valve 235 controls the opening and closing of the ice slurry inlet. If the quantity of the ice slurry measured by the quantity meter 220 is insufficient, the inlet valve 235 on the ice slurry inlet 230 is unlocked to add more ice slurry to the storage container. Contrarily, if the quantity of the ice slurry is sufficient, the inlet valve 235 is locked to prevent further supply of the ice slurry to the storage container. The inlet valve 235 may be wirelessly controlled depending on the quantity or the temperature measured by the quantity meter 220 or the thermometer 210.

The brine outlet 240 is an outlet that discharges a brine converted from the ice slurry when the ice slurry stored in the aging tank 200 is thawed over time. If the brine is left to stand, its temperature is higher than that of the ice slurry contained in the storage container, and thus the thawing of the ice slurry will be accelerated. Therefore, it is preferably to rapidly discharge the brine. The brine outlet 240 is disposed on a lower portion of the storage container and may be opened/closed by the control of the outlet valve 245. The control unit 500 may receive measurement signals from the thermometer 210 and the quantity meter 220 to control the operations of the inlet valve and the outlet valve. The inlet valve and the outlet valve may use various electronically controlled valves.

The brine discharged from the aging tank is transferred to the recovery tank, and the brine contained in the recovery tank is supplied to the brine tank 110 together with sterilized water.

FIG. 3(b) is a diagrammatic view illustrating a configuration of an aging tank 200 according to another embodiment of the present invention. Referring to FIG. 3(b), the aging tank 200 according to another embodiment of the present invention may further include a stirrer 270 and a third mesh 280.

The stirrer 270 stirs the ice slurry in the storage container to uniformly maintain the internal temperature of the aging tank. As the stirrer, a bubble injector or a rotating screw may be used. The ice slurry may be stirred by the stirrer within the aging tank to prevent localized freezing of the food surface.

The third mesh is preferably installed in a 5° to 30° inclined position so that the ice slurry introduced into the storage container through the ice slurry inlet 230 is evenly distributed to the interior of the storage container (250). The third mesh may have a mesh spacing within the range between the mesh spacing of the first mesh and the mesh spacing of the second mesh, but it preferably uses an 18 mesh screen.

FIG. 4 is a block diagram illustrating a configuration of a sterilized water generation unit 300 according to an embodiment of the present invention.

Referring to FIG. 4, the sterilized water generation unit 300 includes a neutralization reaction unit 310 and a mixing unit 320.

The sterilized water generation unit 300 generates sterilized water for sterilizing the meat before low-temperature aging, or supplies the sterilized water to the brine tank 110 to enable the ice slurry generation unit 100 to produce the ice slurry using the sterilized water.

The sterilized water is used to clean a machine or equipment used for dressing out meat by different cuts, as well as to wash the meat, so as to prevent bacterial contamination that may occur during the pre-vacuum packaging stage. It is possible to prevent the deterioration of the meat during the long-term low-temperature aging by vacuum-packaging processed meat using the sterilized water.

Furthermore, when the sterilized water is used to produce and age the ice slurry, bactericidal components contained in the ice slurry inhibit bacterial proliferation.

With the utilization of the sterilized water generation unit 300, neutral sterilized water may be easily generated in the neutral pH range through the neutralization and dilution of sodium hypochlorite (food additive) and dilute hydrochloric acid (food additive).

The neuterization reaction unit 310 safely neutralizes sodium hypochlorite (NaOCl) with dilute hydrochloric acid (HCl). When sodium hypochlorite is neutralized with dilute hydrochloric acid, hypochlorous acid (HOCl) and sodium chloride (NaCl) are formed. The reaction is represented by the following chemical equation 1:

NaOCl+HCl→HOCl+NaCl [Chemical Equation 1]

The mixing unit 320 mixes hypochlorous acid produced by the neutralization reaction unit 310 with an appropriate amount of water to dilute the hypochlorous acid to the desired concentration.

Hypochlorous acid (HOCl) has a superior bactericidal effect compared to sodium hypochlorite (NaOCl) and has the advantages of being free from usage risks and harmful effects.

Hypochlorous acid molecules have the ability to penetrate cell membranes and killing bacteria within the cell. However, a typical sodium hypochlorite solution has a high concentration of hypochlorite ions, making it difficult to expect significant bactericidal effects in a short period of time. Hypochlorite ions cannot penetrate cell membranes and thus act from the outside, gradually destroying the cell membranes over an extended period of time.

The control unit 500 may control a sterilized water valve 350 to be operated to additionally supply the sterilized water contained in the mixing unit to the brine tank when the salinity of the brine in the brine tank 110, measured by the salinity meter 150, is higher than a predetermined salinity value. When the sterilized water is additionally supplied to the brine tank, the concentration of the brine in the brine tank decreases, and as a result, the salinity of the brine in the brine tank 110 may be adjusted. Meanwhile, when the salinity of the brine in the brine tank 110 is low, the control unit may control an appropriate amount of salt from a salt tank (not shown) connected to the recovery tank by means of a valve to be additionally supplied to the recovery tank to increase the salinity of the brine in the brine tank.

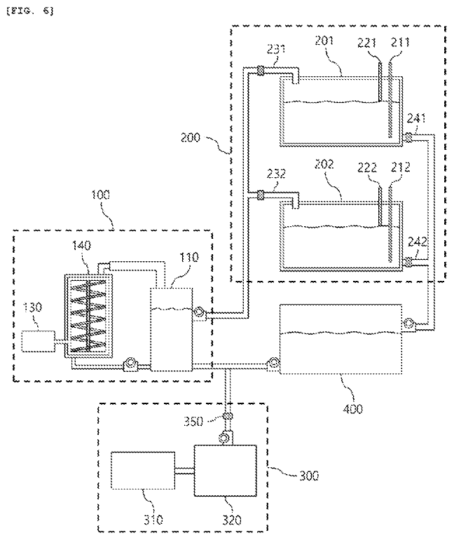

FIG. 5 is a graph depicting the concentrations of hypochlorous acid (HOCl) and hypochlorite ion (OCl—) along with the time required to kill E. coli.

FIG. 5 is a graph depicting the time required to kill E. coli., when hypochlorous acid (HOCl) and hypochlorite ion (OCl—) have the same concentration.

Referring to FIG. 5, it can be seen that when the chlorine concentration is 0.1 ppm, hypochlorous acid (HOCl) achieves a 99% death of E. coli within 1.5 minutes, while hypochlorite ion (OCl—) achieves a 99% death of E. coli. within 120 minutes.

According to an embodiment of the present invention, slightly acidic hypochlorous acid water (hereinafter referred to as “hypochlorous acid water”) with an active chlorine concentration of 10 to 80 ppm at a pH of 5.0 to 6.5 is added to a 2% to 3.5% brine to produce an ice slurry. When the thus produced ice slurry is used for storage of fresh food, the hypochlorous acid water released or dissolved directly from the ice slurry comes into contact with the surface of the fresh food, so that spoilage-causing bacteria such as E. coli, Staphylococcus aureus, and Vibrio harveyi on the surface of food can be rapidly killed due to high bactericidal activity of hypochlorous acid, significantly contributing to the improvement of freshness preservation of the food.

Particularly, when hypochlorous acid water is added to brine to produce an ice slurry, salt itself does not have the bactericidal activity. However, when the brine comes into contact with microorganisms such as bacteria and fungi, an aqueous solution including intracellular protoplasm, tends to diffuse towards the brine side of a high concentration based on the principle of osmotic pressure, leading to the weakening or death of microorganisms. Therefore, mixing hypochlorous acid water with the brine and using it for ice production has an enhanced effect in preventing microbial proliferation.

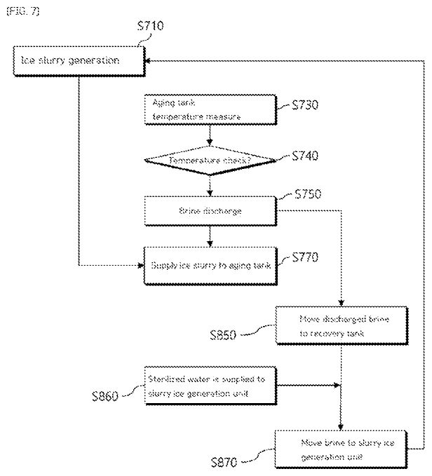

FIG. 6 is a diagrammatic view illustrating the entire configuration of a low-temperature aging apparatus using ice slurry according to an embodiment of the present invention.

Referring to FIG. 6, the low-temperature aging apparatus using ice slurry according to an embodiment of the present invention includes an ice slurry generation unit 100, an aging tank 200, a sterilized water generation unit 300, a recovery tank 400, and a control unit 500.

The ice slurry generation unit 100 adjusts the salinity of the brine to produce an ice slurry of a desired temperature. When the ice slurry is filled in the brine tank 110, it is transferred to the aging tank 200 through the pump.

The aging tank 200 stores, at a constant temperature, food desired to be aged, in the ice slurry produced from the ice slurry generation unit 100 and supplied thereto for the purpose of low-temperature aging. The aging tank 200 may be configured in plural numbers. Plural aging tanks 201 and 202 may be connected in parallel to the brine tank. Inlet valves 231 and 232 are separately provided on the aging tanks 201 and 202, respectively, so that the ice slurry generation unit can provide the ice slurry produced through the change of the salinity to each of the aging tanks to fit the temperature of each aging tank.

When the ice slurry contained in the aging tank 200 is thawed to be converted into a brine over time, the brine is transferred to the recovery tank 400. The brine is then stored in the recovery tank 400 and is supplied to the brine tank 110, if necessary.

The sterilized water generation unit 300 generates sterilized water to sterilize food before low-temperature aging of the food, or supplies the sterilized water to the brine tank 110. The sterilized water generation unit 300 may be disposed between the recovery tank 400 and the ice slurry generation unit 100 and may be connected to the recovery tank 400 and the ice slurry generation unit 100 by means of the sterilized water valve 350.

The brine tank 110 is supplied with sterilized water from the sterilized water generation unit 300, and is supplied with the brine from the recovery tank 400 to produce the ice slurry. A salinity measurement instrument or a salinity meter 150 is installed in the brine tank 110, and the control unit 500 may controls the amount of the brine and the sterilized water to become a brine with a predetermined salinity.

When the ice slurry contained in the aging tank 200 is thawed to be converted into a brine over time, the recovery tank 400 is supplied with the brine from the aging tank 200 and supplies the brine to the brine tank 110. The recovery tank 400 is connected to the brine outlet 240 of the aging tank to store the brine supplied from the aging tank therein. The stored brine is supplied to the brine tank of the ice slurry generation unit.

The control unit 500 receives measurement signals from the thermometer 210 and the quantity meter 220 of the aging tank to control the operations of the inlet valve 235 and the outlet valve 245. The control unit 500 controls the brine to be discharged to the recovery tank through the brine outlet 240 and controls ice slurry to be supplied to the aging tank through the ice slurry inlet 230 if the temperature of the ice slurry contained in the aging tank goes beyond a predetermined temperature rang).

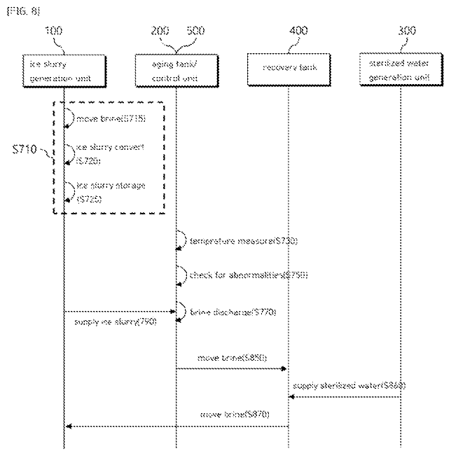

FIG. 7 is a control flowchart illustrating a low-temperature aging method using ice slurry according to an embodiment of the present invention, and FIG. 8 is a flowchart illustrating a low-temperature aging method using ice slurry by constituent element according to an embodiment of the present invention.

Referring to FIGS. 7 and 8, the low-temperature aging method using ice slurry according to an embodiment of the present invention consists of sequential steps, which are processed in a time-series manner in the low-temperature aging apparatus using ice slurry shown in FIG. 6. Thus, even though the above-mentioned description regarding the low-temperature aging apparatus using ice slurry shown in FIG. 6 is omitted below, it is also applied to the low-temperature aging method using ice slurry according to an embodiment of the present invention. The low-temperature aging method according to an embodiment of the present invention is a method that ages food without freezing the food at a low temperature below freezing using ice slurry containing salt.

As a pre-treatment step, hypochlorous acid sterilized water is used to clean and sterilize all equipment used in the meat dressing-out step. Simultaneously, the meat is coated with an appropriate concentration of hypochlorous acid sterilized water to be sterilized before vacuum packaging the meat. The vacuum-sealed meat is then immersed in the ice slurry for maturation as described below.

The ice slurry generation unit produces an ice slurry with a uniform salinity (S710).

The ice slurry producing step (S710) includes a step (S715) of being supplied with a brine from the brine tank and transferring the brine to the interior of the ice slurry transfer unit, a step (S720) of cooling the ice slurry transfer unit to a temperature below the freezing point of the brine and converting the brine passing through the interior of the ice slurry transfer unit into the ice slurry; and a step (S725) of storing the converted ice slurry in the brine tank.

The control unit receives the temperature of an ice slurry of the aging tank, which is measured by the thermometer of the aging tank, from the thermometer (S730).

The control unit checks whether or not the temperature of the ice slurry goes beyond a predetermined temperature range (S740). The control unit controls the brine to be discharged to the recovery tank through the brine outlet by opening the outlet valve if the temperature of the ice slurry goes beyond the predetermined temperature range (S750).

The control unit checks a signal outputted from the quantity meter and controls the inlet valve to be opened to supply the ice slurry to the aging tank through the ice slurry inlet until the level of the ice slurry reaches a predetermined height (S770).

When the brine contained in the aging tank is discharged, the control unit transfers the brine discharged from the aging tank by driving the pump to the recovery tank (S850). The brine of the recovery tank may be transferred to the ice slurry generation unit using the pump for circulation (S870). The sterilized water generated from the sterilized water generation unit may be supplied to the brine that is transferred to the ice slurry generation unit (S860).

According to an embodiment of the present invention, in order to progress aging, aging may be divided into small-scale aging and large-scale aging.

First, for the small-scale aging, the ice slurry generation unit 100 and the aging tank 200, which are made of a material that is resistant to oxidation, are configured in sets.

A transparent aging tank 200 with a visible interior, made of the same material as that of a tank for storing live fish in a brine contained in the tank, is manufactured. Thereafter, the ice slurry generation unit 100 is coupled to the aging tank 200, and then a temperature sensor is installed in the aging tank 200 so that if the internal temperature of the aging tank 200 rises above a desired temperature range, the ice slurry generation unit 100 is operated to supply an ice slurry to the aging tank 200 to lower the internal temperature of the aging tank 200, while if the internal temperature of the aging tank 200 falls within the desired temperature range, the operation of the ice slurry generation unit 100 is automatically stopped, enabling efficient operation.

Meanwhile, for the large-scale aging process on a factory basis, large capacity aging tanks are consecutively installed which are equipped with a lid made of a material resistant to oxidation by brine (see reference numeral “200” of FIG. 6). Thereafter, ice slurry inlets 231 and 232 and opening/closing valves are installed at the upper end of the large capacity aging tanks, while brine outlets 241 and 242 and opening/closing valves are installed at the lower end thereof. In this case, the ice slurry inlets 231 and 232 and the opening/closing valves installed at the upper end of the aging tanks are connected in parallel together, respectively, which are then connected to the brine tank 110, and the brine outlets 241 and 242 and the opening/closing valves installed at the lower end of the aging tanks are connected in parallel together, respectively, which are then connected to the recovery tank 400.

A temperature sensor and a wireless communication unit are installed at each of the aging tanks so that if the internal temperature of the aging tank rises above a predetermined temperature range, the opening/closing valves mounted on the brine outlets 241 and 242 are opened to discharge the brine, and simultaneously the opening/closing valves mounted on the ice slurry inlets 231 and 232 are opened to supply the ice slurry. If the internal temperature of the aging tank falls within the predetermined temperature range after a lapse of a certain time period, it is detected by the temperature sensor to allow the opening/closing valves mounted on the ice slurry inlets 231 and 232, and the brine outlets 241 and 242 to be locked through the wireless communication unit.

Herein, the brine discharged from the aging tank is collected in the recovery tank 400 to be supplied to the brine tank. When an ice slurry of a desired temperature is again produced, it is stored in the brine tank 110 and then supplied to the aging tank 200.

In the above embodiment, the sensing valves and the control signals from the pump, the temperature sensor, and the opening/closing valve are transmitted to a server or the control unit through separate wireless communication so that the low-temperature aging apparatus according to the present invention can be operated automatically. Examples of the wireless communication may include LTE, WiFi, Bluetooth, Zigbee and the like.

### Example

After a 1 kg piece of sirloin beef was vacuum-packaged, it was charged into a low-temperature aging apparatus using ice slurry and subjected to low-temperature aging. After two weeks of aging, a 1 kg piece of sirloin beef with the same grade as that of the sirloin beef previously subjected to low-temperature was vacuum-packaged and then additionally charged into the low-temperature aging apparatus using ice slurry to be subjected to low-temperature aging. After 4 weeks, sirloin aged for 4 weeks and sirloin aged for 2 weeks were compared and tested with unaged sirloin of the same grade as those of the 4-week-aged sirloin and the 2-week-aged sirloin.

Each sirloin sample having a red-colored flesh was sliced into a dimension of 5 mm thickness, 50 mm width, and 100 mm height. The sirloin slices were then placed on a hot plate heated to 200° C., and the front sides thereof were seared for 1 minute, followed by searing the back sides thereof for 1 minute. For the seared samples, blind evaluations were conducted based on appearance, texture, and taste, on a 10 point scale (with 5 points assigned to the unaged product) as the criteria. The results of the evaluations were shown in Table 3 below.

Meanwhile, in order to evaluate the texture, the sirloin samples seared on the hot plate was left to stand at room temperature for 5 minutes to lower the temperature of the samples. Subsequently, the stress (hardness) was measured while penetrating the flesh of the sirloin samples using a needle-type plunger with a thickness of 3 mm and a rheometer.

In order to evaluate the taste, the sirloin samples were extracted using the perchloric acid extraction method, and the free amino acids were measured using the high-performance liquid chromatography (HPLC).

TABLE 3

| | Unaged | 2-week-aged | 4-week-aged |
|---|---|---|---|
| | sirloin | sirloin | sirloin |
| Appearance | Good | Good | Good |
| Texture | 5 | 7 | 8 |
| (degree of | | | |
| tenderness) | | | |
| Taste (level | 5 | 7 | 8 |
| of flavor) | | | |
| Hardness (g) | 236.2 | 212.8 | 208.6 |
| Glutamic | 3.7 | 9.6 | 16.6 |
| acid (mg/100 g) | | | |
| Glycine | 4.5 | 6.3 | 8.3 |
| (mg/100 g) | | | |
| Alanine | 20.0 | 24.0 | 32.3 |
| (mg/100 g) | | | |
| Taurine | 3.8 | 20.5 | 21.5 |
| (mg/100 g) | | | |
| Total free | 389.6 | 486.9 | 557.2 |
| amino acids | | | |
| (mg/100 g) | | | |

Referring to the measurement results of the properties of the unaged and aged sirloin samples as shown in Table 3 above, it could be observed that the aged products have a favorable appearance and exhibit a smoother texture and better taste compared to the non-aged product. Therefore, it could be concluded that when the aging of meat for 2 to 4 weeks using the low-temperature aging apparatus with ice slurry has a positive effect on texture and taste.

It could be seen from Table 3 above that as the aging period increases to 0 weeks, 2 weeks, and 4 weeks in this order, the hardness gradually decreases to 236.2 g, 212.8 g, and 208.6 g in this order, indicating a gradual improvement in tenderness of the meat.

As the levels of free amino acids such as glutamic acid, glycine, and alanine increase, the flavor intensity also increases. With the increase in aging period, the levels of the free amino acids also rise to 389.6 mg/100 g, 486.9 mg/100 g, and 557.2 mg/100 g in this order, indicating an increase in flavor intensity corresponding to the longer aging period.

As described above, although the present invention has been described with reference to specific details such as detailed elements, the limited embodiments, and the accompanying drawings, they are only provided to help a more general understanding of the present invention, but the present invention is not limited to the exemplary embodiments. In addition, various modifications and changes may be made by those skilled in the art to which the present invention pertains from this description.

Therefore, the spirit of the present invention should not be limited to these exemplary embodiments, but the appended claims and all of modifications equal or equivalent to the claims are intended to fall within the scope and spirit of the present invention.

1. A low-temperature aging apparatus that ages food at a low temperature below freezing using ice slurry containing salt, the apparatus, comprising:
an ice slurry generation unit configured to produce and supply an ice slurry with a uniform salinity;
an aging tank comprising a storage container configured to store food that is desired to be aged at a low temperature, an ice slurry inlet formed on an upper portion of the storage container and connected to the ice slurry generation unit, an inlet valve configured to control the opening and closing of the ice slurry inlet, a brine outlet disposed on a lower portion of the storage container and configured to discharge a brine, an outlet valve configured to control the opening and closing of the brine outlet, a quantity meter configured to measures the quantity of the ice slurry contained in the aging tank, and a thermometer configured to measure the temperature of an ice slurry contained in the aging tank; and
a control unit configured to receive measurement signals from the thermometer and the quantity meter to control the operations of the inlet valve and the outlet valve,
wherein the control unit controls the brine to be discharged through the brine outlet and controls ice slurry to be supplied to the aging tank through the ice slurry inlet if the temperature of the ice slurry contained in the aging tank goes beyond a predetermined temperature range.

2. The low-temperature aging apparatus using ice slurry according to claim 1, wherein the ice slurry generation unit comprises:
a brine tank configured to store the brine therein;
an ice slurry transfer unit configured to cool the brine supplied from the brine tank while transferring the brine and convert the cooled brine into the ice slurry; and
a cooling unit configured to cool the internal temperature of the ice slurry transfer unit to a temperature below the freezing point of the brine.

3. The low-temperature aging apparatus using ice slurry according to claim 1, further comprising a recovery tank connected to the brine outlet of the aging tank and configured to store the brine transferred (discharged) from the aging tank and to supply the stored brine to the ice slurry generation unit.

4. The low-temperature aging apparatus using ice slurry according to claim 3, further comprising a sterilized water generation unit disposed between the recovery tank and the ice slurry generation unit and configured to supply sterilized water to the ice slurry generation unit.

5. The low-temperature aging apparatus using ice slurry according to claim 4, wherein the sterilized water generation unit comprises:
a neutralization reaction unit configured to neutralize sodium hypochlorite (NaOCl) with dilute hydrochloric acid (HCl); and
a mixing unit configured to mix hypochlorous acid produced by the neutralization reaction unit with water.

6. A low-temperature aging method that ages food at a low temperature below freezing using ice slurry containing salt, the method comprising the steps of:
allowing an ice slurry generation unit to produce an ice slurry with a uniform salinity;
allowing a control unit to receive the temperature of an ice slurry of an aging tank, which is measured by a thermometer of the aging tank, from the thermometer;
allowing the control unit to check whether or not the temperature of the ice slurry goes beyond a predetermined temperature range;
allowing the control unit to control an outlet valve to be opened to discharge a brine through a brine outlet if the temperature of the ice slurry goes beyond the predetermined temperature range; and
allowing the control unit to check a signal outputted from a quantity meter and control an inlet valve to be opened to supply the ice slurry to the aging tank through an ice slurry inlet until the level of the ice slurry reaches a predetermined height.

7. The low-temperature aging method using ice slurry according to claim 6, wherein the ice slurry producing step comprises the steps of:
being supplied with a brine from a brine tank and transferring the brine to the interior of an ice slurry transfer unit
cooling the ice slurry transfer unit to a temperature below the freezing point of the brine and converting the brine passing through the interior of the ice slurry transfer unit into the ice slurry storing the converted ice slurry in the brine tank.

8. The low-temperature aging method using ice slurry according to claim 6, further comprising the steps of:
transferring the brine contained in the aging tank to a recovery tank; and
transferring the brine of the recovery tank to the ice slurry generation unit.

9. The low-temperature aging method using ice slurry according to claim 6, further comprising supplying sterilized water to the ice slurry generation unit.
